(19) United States
(12) Patent Application Publication
(10) Pub. No.: US 2023/0314248 A1
(43) Pub. Date: Oct. 5, 2023

(54) Automated Load Testing Tool and Methods of Use Therefor

(71) Applicant: Paragon Films, Inc., Broken Arrow, OK (US)

(72) Inventor: Tom Roudebush, Broken Arrow, OK (US)

(21) Appl. No.: 18/207,789

(22) Filed: Jun. 9, 2023

Related U.S. Application Data
(63) Continuation of application No. 17/383,826, filed on Jul. 23, 2021, now abandoned.
Application No. 17/383,826 is a continuation of application No. 17/119,934, filed on Dec. 11, 2020, now abandoned.
(60) Provisional application No. 62/946,707, filed on Dec. 11, 2019.

(51) Int. Cl. G01L 5/04

(52) U.S. Cl. CPC G01L 5/04

(57) ABSTRACT

According to one aspect of the invention, an automated load testing tool suitable for use when field testing stretch film load containment forces is provided. According to a further aspect, the tool safely, reliably and accurately measures load containment forces in a time- and cost-effective manner, and ensures that operators cannot manipulate the test results. According to a still further aspect, the tool is used to accurately measure stretch film stiffness after application to a wrapped load. According to yet another aspect, the test unit is attached to a load that has already been wrapped with stretch film, and the unit automatically hooks and then pulls the film a predefined distance at a predefined rate so that the load force needed to displace the film is accurately measured.

### CROSS-REFERENCES TO RELATED APPLICATIONS

This patent application claims benefit of U.S. patent application Ser. No. 17/383,826, filed Jul. 23, 2021, which claims benefit of U.S. patent application Ser. No. 17/119,434, filed Dec. 11, 2020, which claims benefit of U.S. Provisional Patent Application No. 62/946,707, filed Dec. 11, 2019, the contents of which are hereby incorporated by reference in their entirety.

### TECHNICAL FIELD

The present invention relates generally to methods and means for reliably and accurately measuring and/or recording various stretch film properties, and in a particular though non-limiting embodiment to an automated load testing tool suitable for field testing the load containment force of stretch wrap films.

### BACKGROUND

A wide variety of bundling and packaging applications employ stretch films. For example, machine and hand stretch films are frequently used to secure bulky loads such as boxes, merchandise, produce, equipment, parts and other similar items on pallets.

Distortion and damage can be minimized or avoided when stretch film having properties particularly suited for the application in question are used to wrap and contain the loads. For example, depending on the particular application, a number of different stretched film characteristics might be considered important, such as load containment, puncture resistance, noise reduction, clarity, etc.

To date, several previously known hand tools and crudely automated devices have been used to measure load containment force in the field. Such tools have proven unreliable, however, as their results are easily manipulated by operators who can vary the location of the tool, the pulling force applied to the film, the time period during which the test is carried out, etc. In this manner, inferior films can appear stronger and more robust than they actually are.

There is, therefore, a longstanding but currently unmet need for a tool that safely, reliably and accurately measures the load strength containment force in a time- and cost-effective manner, while avoiding the deleterious performance characteristics of the prior art, and in particular for a test that measures stretch film stiffness and load containment in a manner that reduces or eliminates the ability of the tester to affect the accuracy of the testing results.

### SUMMARY

The present invention is drawn to an automated load testing tool suitable for use when field testing stretch film load containment forces. The tool safely, reliably and accurately measures load containment forces in a time- and cost-effective manner, and ensures that operators cannot manipulate the test results. In essence, the tool is used to accurately measure stretch film stiffness after application to a wrapped load.

In one embodiment, the test unit is attached to a load that has already been wrapped with stretch film, and the unit automatically hooks and then pulls the film a predefined distance at a predefined rate so that the load force needed to displace the film is accurately measured.

In another embodiment, the test measures load stability in a non-destructive field test using a portable testing apparatus, without the possibility that a human operator can affect the test results by pulling the film at a different or unknown rate, too far (or not far enough), for an insufficient period of time, etc.

In a further embodiment, a grasping device (for example, a hook or other suitable element) securely hooks the film prior to stretching. A plurality of opposed support arms are then fixed to rest on opposite sides of the film to counter the pulling force. Finally, an electronic actuator or the like is used to pull the hooked film to a given distance at a given rate, and then display a measure of the pounds of force required to stretch the film.

In one embodiment the means for displaying the measure of required pounds of force comprises an automated load cell used to generate a read out or digital display, etc., of the containment force measurement number. In other embodiments, the measuring means stores information regarding the results of a series of tests for verification and comparison purposes.

In still further embodiments the hooking element mechanically engages a plate or the like inserted beneath the surface of the film, engagement being accomplished by hooking or otherwise interlocking opposing elements disposed on the tool and the plate.

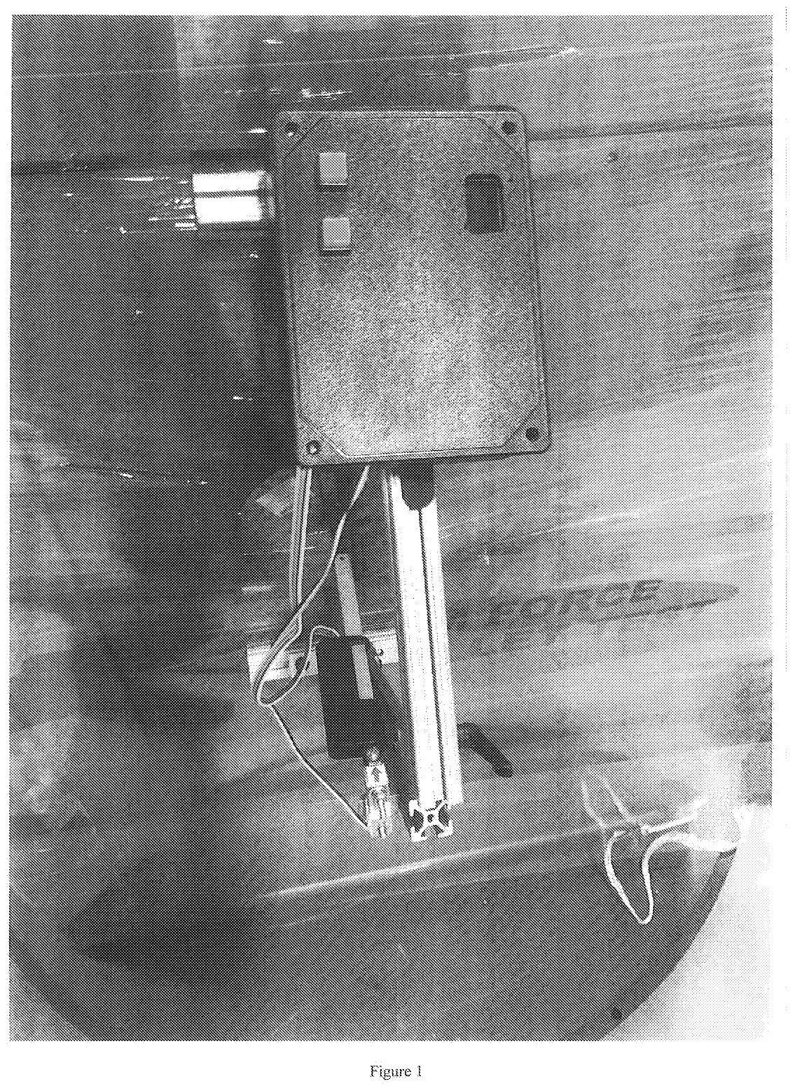

As seen in the example embodiment depicted in FIG. 1, a top view of an automated load testing tool according to the disclosure is shown in which a testing arm is mechanically engaged with a plate disposed beneath the surface of the film. In alternative embodiments there is no plate beneath the film, and a grasping hook or the like simply grasps a sufficient volume of stretch film to suffice for the purpose of measuring an opposing load force. In the example, a plurality of stabilizing legs (in this instance, two stabilizing legs) is extended opposite one another and on either side of the plate and hook assembly so that the tool is safely secured for the stretch film load test.

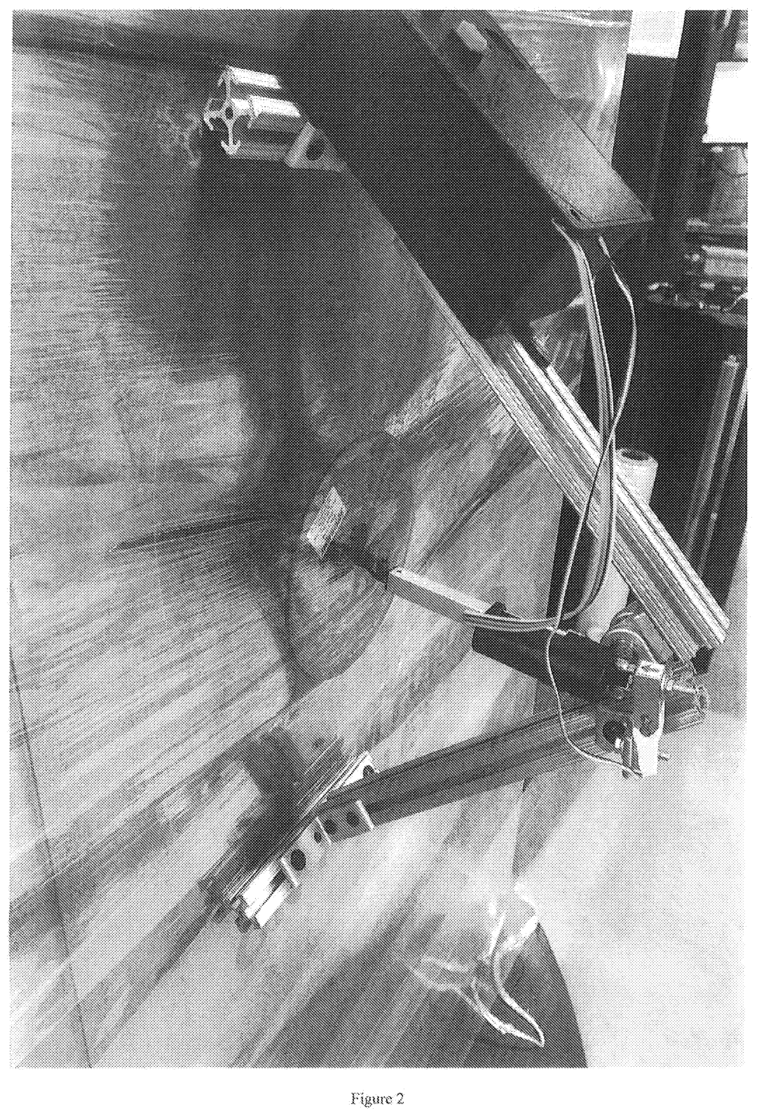

The example embodiment of FIG. 2 shows a side view of the structure and functionality described in detail above and illustrated in FIG. 1.

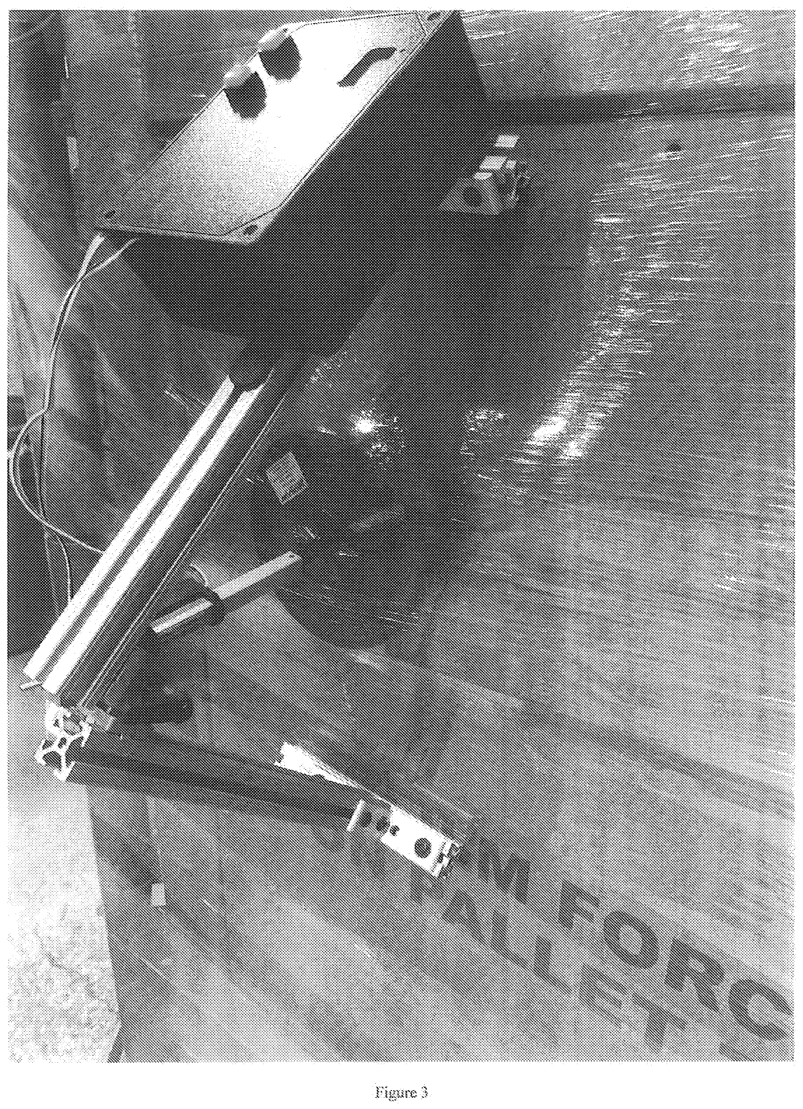

The example embodiment of FIG. 3 shows a side view of the tool in use, wherein an actuator has actuated a pulling force transmitted by the actuator to the testing arm, and ultimately to the grasping element and plate assembly. In this example, it can be seen that the testing arm is retracting, away from the surface of the film, and that the plate is beginning to stretch the film so that the load cell can measure and/or record and/or store the measured pulling force.

In this manner a measuring test with high integrity is assured, and, unlike the devices in the prior art, cannot be manipulated by a human operator. The load containment force of competing stretch films can also be measured in series, yielding comparative data indicative of the true load containment force of the competing films.

An exemplary method for measuring stiffness and compression of stretch film is known, comprising use of the automated load testing protocol described herein.

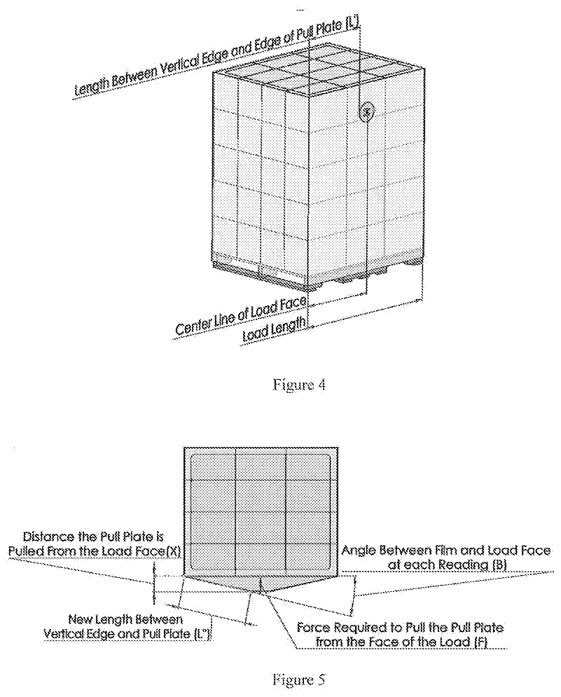

With reference now to FIGS. 4 & 5 (FIG. 4 being a three-quarter view of a generic side of the test frame, and FIG. 5 being a top view of a unit load, with a component break-down with forces associated with modeling f_{af} and the thick gray bar representing the pull plate), the example method begins by wrapping the load with the desired film and machine settings.

On the longer side of the load, the pull plate is inserted between the film and the product at the centerline and positioned at a predetermined measured location; in the non-limiting example presented, the predetermined measured location is disposed approximately 254 mm (10.0 inches) from the top of the product.

Ordinarily skilled artisans will readily appreciate, however, that if the example testing position is not ideal, another location can be specified so long as the chosen position is disposed at the centerline and is kept consistent across all tests that may be compared.

Then, a consistent time interval is selected to let the wrapped load stand undisturbed between the end of the wrap cycle and starting of the test. In one example embodiment, the resting interval should be at least 5 a minute time interval, though other intervals can be employed with equal or even superior efficacy.

The pull plate is then placed behind the stretch film along the center line of the load, and holes are cut in designated locations so as to allow insertion of a ruler and airflow. A pull force gauge is then used to pull the plate from the face of the load.

Force values are then recorded at a plurality of predetermined intervals, for example, at 51, 76, 102, 127, and 152 mm (2.0, 3.0, 4.0, 5.0, and 6.0 inches, respectively) in kilograms force (or pounds), and used in conjunction with Equation 1 below to calculate compression force and film tension.

$$\frac{F}{2 * sin ( β )} = ( S * Δ L + T ) + error \qquad Equation 1$$

Where:
F=Applied stretch film Force measured on Face
β=Angle between the face of the load and the stretch film
S=Stiffness of the Applied film
L′=Length between the edge of the load and the edge of the pull plate prior to evaluation
L″=Length between the edge of the load and the edge of the pull plate during evaluation
ΔL=Change in length between L′ and L″
T=Film Tension across the face of the load

Note that during testing it is possible for films to slip around the vertical edge (or corner) of the load, and differing cling levels will have an effect on slippage and in turn effect the forces measured during testing.

One way to counteract these forces is to cover both sides of the vertical edges of the load with a polymeric material (for example, box tape). This precaution helps prevent slippage of the film around the corner of the load during evaluation.

In another embodiment, film tension from either side of the unit load (which was calculated in Equation 1) is used to calculate the load containment force (in other words, the force pushing inward on the corner of a load) using Equation 2.

C=\sqrt{(T₁)²+(T₂)²} Equation 2
Where:
C=Compression force
T₁=Film Tension of the film on one side of the load
T₂=Film Tension on the second side of the load.
NOTE: Film tension only needs to be measured once for a square load. Thus, here T₁=T₂

In such manner, all forces needed to properly evaluate the sample in a fair, unbiased and repeatable process are accurately calculated, and user manipulation possibility is avoided.

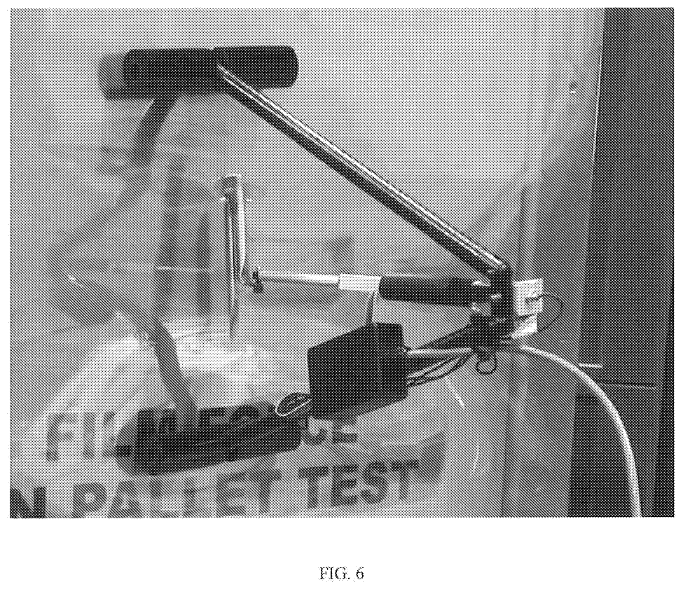

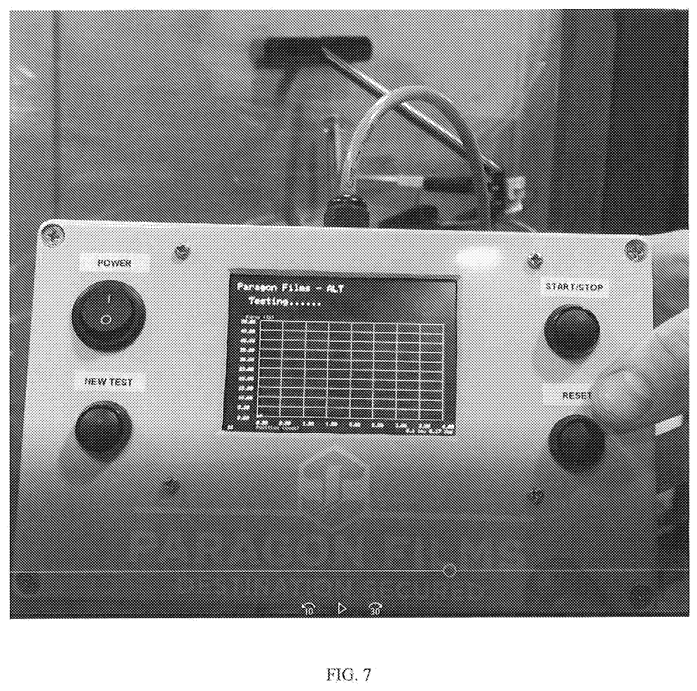

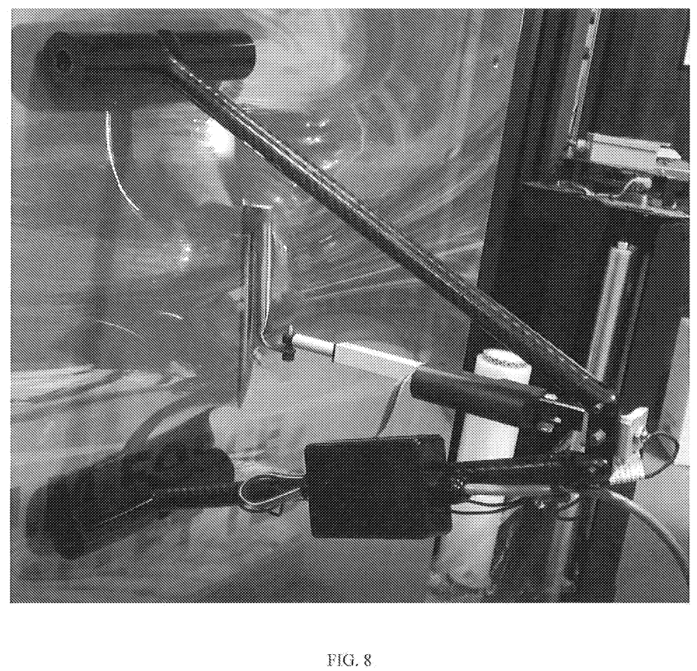

FIGS. 6-8 illustrate another embodiment of the claimed device; a graphical user interface for use in association therewith; and a still further embodiment in which an entire film characteristic measuring system is shown, respectively.

The foregoing specification is provided only for illustrative purposes, and is not intended to describe all possible aspects of the present invention. While the invention has herein been shown and described in detail with respect to several exemplary embodiments, those of ordinary skill in the art will readily appreciate that minor changes to the description, and various other modifications, omissions and additions may also be made without departing from the spirit or scope thereof.

1. An automated testing tool for measuring and recording stretch film properties, wherein said automated testing tool is configured to measure and record the load containment force of stretch wrap film.
